(19) United States
(12) Patent Application Publication
(10) Pub. No.: US 2024/0130563 A1
(43) Pub. Date: Apr. 25, 2024

(54) Smart Cooktop System and Method of Using Same

(71) Applicant: Robert Bosch GmbH, Stuttgart (DE)

(72) Inventor: Xiaowei Zhou, Fremont, CA (US)

(21) Appl. No.: 17/972,286

(22) Filed: Oct. 23, 2022

(51) Int. Cl. A47J 36/32; G06V 10/70; G06V 10/75; G06V 20/50; H04N 5/247; H05B 3/74

(52) U.S. Cl. CPC A47J 36/321; G06V 10/70; G06V 10/75; G06V 20/50; H04N 5/247; H05B 3/746; F24C 7/083

(57) ABSTRACT

A cooktop system is configured to detect cooking events during a cooking process performed on a cooktop. The system includes a cooktop having one or more cameras integrated into the cooking surface and a controller that is configured to receive the image data generated by the cameras, process the image data to identify a corresponding cooking event, and perform a response function based on the identified cooking event.

### BACKGROUND

Cooktop or range appliances generally include a cooking surface having heating elements for heating cooking utensils, such as pots, pans and griddles. The heating elements may be located in, on or below the cooking surface and can be arranged in various configurations across the cooking surface. The number of heating elements can include, for example, four, six, or more depending upon the intended application and user preferences. The heating elements can vary in size, location, and capability. In use, a cooking utensil such as a pot is placed on a respective heating element and the heating element is heated whereby heat is transferred to the pot via conduction, induction and/or convection depending on the type of heating element. However, when cooking using the cooktop, the user must frequently, if not constantly, observe the cooking utensil and check the status of heating of the cooking utensil to avoid the occurrence of undesirable or hazardous events, such as overflow, overheating and/or burning, which may be associated food waste, heavy smoke and/or damage to the cooking utensil or, in extreme cases, damage to the cooktop.

It is desirable to have a cooktop system that facilitates safe and convenient use of the appliance. In addition, improved cooktop systems that facilitate user engagement and interaction during use of a cooktop are needed.

### SUMMARY

A smart cooktop system is provided that facilitates user engagement and interaction during use of a cooktop appliance. As used herein, the term “smart cooktop system” refers to a cooktop system that is capable of communication and exchange of information with remote devices, systems and/or users, can be programmed or controlled remotely and/or can be operated autonomously. For example, the cooktop system can monitor the cooking process and identify the status and stage of the cooking process and permit remote electronic sharing or accessing images and information from the cooktop system. In addition, the cooktop system may be connected a cooking assistance application, facilitating user engagement and interaction during use of the cooktop appliance. Moreover, the cooktop can detect a hazardous event and automatically trigger an alarm or other appropriate response including controlling power to the heating element(s), facilitating safe use of the cooktop system.

The smart cooktop system includes a cooktop, camera modules deployed in the cooktop and a controller that receives information from the camera modules. Based on the information received from the cameras, the controller may control the heating elements, send notifications or alerts, store data for use in artificial intelligence (AI, for example, by employing machine learning) or other appropriate action. To this end, the cooktop may include transparent viewing regions that serve as viewing windows and a camera that is installed underneath the cooktop surface at each viewing window. The transparent viewing regions enable the cameras to view the area immediately above the cooktop outer surface including the area occupied by the cooking utensils. The cameras observe the cooking utensils and cooking area to:
detect hazardous events, such as cooking utensil overflows or abnormal smoking/burning of cooking utensils, allowing the controller to then trigger an alarm to remind the human or shut down the cooktop automatically; and
detect cooking events (such as water is boiling) which can then be associated by the controller with the status/stage of the cooking. In addition, or alternatively, a message can be sent to cooking assistance applications (for example, Smartphone Apps) to update the status or trigger next steps in a process being dictated by the applications (e.g., add ingredients to the water, change the power level in different stage of cooking).

AI algorithms for identifying cooking events may be applied in the controller of the cooktop system. At same time, cooktop system may have remote network (e.g., internet) connection ability to update the machine learning algorithms and models via cloud computing, to allow system data to be stored and/or used remotely or to allow other appropriate tasks to be performed.

In the cooktop system described herein, the cameras are coupled to the cooktop, e.g., they are integrated into the cooktop itself. As a result, the cameras are securely mounted to the cooktop and the viewing areas detected by a given camera may be adjusted and set during cooktop manufacture. This can be advantageous relative to some other cooktop systems in which the cameras are decoupled from the cooktop (i.e., a system in which the camera is mounted at a location that is remote from the cooktop), since proper camera adjustment and orientation may be difficult to achieve during installation in a decoupled system.

In some aspects, a cooktop includes a base panel including an outer surface, an inner surface that is opposite the outer surface and a transparent first viewing region. The cooktop includes a first heating element that is secured to the inner surface in such a way as to be able to supply heat to a first heating region of the base panel. The cooktop includes a first camera that is positioned on a side of the base panel corresponding to the inner surface at a location corresponding to the first viewing region. The first camera is configured to collect image data from a first imaging volume, where the first imaging volume is positioned on a side of the base panel corresponding to the outer surface at a location corresponding to the first heating region and the first camera views the first imaging volume through the first viewing region. In addition, the cooktop includes a controller that is configured to receive the image data collected by the first camera, process the image data to identify a corresponding cooking event, and perform a response function based on the identified cooking event.

In some embodiments, the first imaging volume has a conical shape, an apex of the conical shape is located on the camera and an axis of the conical shape extends through the first viewing region and the first imaging volume.

In some embodiments, the axis of the conical shape is at an acute angle relative to a plane defined by the base panel.

In some embodiments, the first viewing region has a circular shape when the base panel is viewed in a direction perpendicular to the outer surface.

In some embodiments, the first viewing region has a circular sector shape when the base panel is viewed in a direction perpendicular to the outer surface.

In some embodiments, the base panel comprises a transparent second viewing region. In addition, the cook top includes a second heating element that is secured to the inner surface in such a way as to be able to supply heat to a second heating region of the base panel and a second camera that is positioned on a side of the base panel corresponding to the inner surface at a location corresponding to the second viewing region. The second camera is configured to collect image data from a second imaging volume, where the second imaging volume is positioned on a side of the base panel corresponding to the outer surface at a location corresponding to the second heating region and the second camera views the second imaging volume through the second viewing region.

In some embodiments, the first imaging volume and the second imaging volume partially overlap.

In some embodiments, the controller is configured to receive the image data collected by each of the first camera and the second camera, process the collected image data including using data from one of the first camera or the second camera to compensate for or supplement data from the other of the first camera and the second camera, and identifying a corresponding cooking event. The controller is also configured to perform a response function based on the identified cooking event.

In some aspects, a system for detecting cooking events during a cooking process performed on a cooktop includes the cooktop. The cooktop includes a base panel comprising an outer surface, an inner surface that is opposite the outer surface and a transparent first viewing region. The cooktop includes a first heating element that is secured to the inner surface in such a way as to be able to supply heat to a first heating region of the base panel. In addition, the cooktop includes a first camera that is positioned on a side of the base panel corresponding to the inner surface at a location corresponding to the first viewing region. The first camera is configured to detect image data in a first imaging volume, where the first imaging volume is positioned on a side of the base panel corresponding to the outer surface at a location corresponding to the first heating region and the first camera views the first imaging volume through the first viewing region. The system also includes a controller that is configured to receive the image data generated by the first camera, process the image data to identify a corresponding cooking event, and perform a response function based on the identified cooking event.

In some embodiments, processing the image data to identify cooking events includes analyzing the image data to identify image contents, comparing the image contents to a pre-stored content library that includes known images of cooking events and at least one response function that is mapped to each known image of a cooking event. In addition, processing the image data to identify cooking events includes identifying a one of the known cooking events that most closely matches the image contents, and based on the identified one of the known cooking events, performing the response function or response functions that are mapped to the one of the known cooking events.

In some embodiments, analyzing the image data to identify image contents is performed using artificial intelligence algorithms.

In some embodiments, the controller comprises a communication device that is configured to transmit information to, and receive information from, a remote network.

In some embodiments, information transmitted to the remote network includes cooking event data.

In some embodiments, analyzing the image data to identify image contents is performed using an artificial intelligence algorithm stored by the controller, and information received from the remote network includes updates to the artificial intelligence algorithm that improve the function of the artificial intelligence algorithm.

In some embodiments, the at least one response function comprises activating at least one of an audible alarm, a visible alarm, transmission of an alert to a personal computing device via the remote network, transmission of an alert to a public safety organization via the remote network, transmission of an alert to a private security organization via the remote network.

In some embodiments, the at least one response function comprises controlling the first heating element to change an amount of heat provided by the heating element.

In some embodiments, the at least one response function comprises controlling the first heating element to change an operation state of the heating element.

### BRIEF DESCRIPTION OF THE DRAWINGS

FIG. 1 is a top plan view of a cooktop of a cooktop system.

FIG. 2 is a top plan view of the cooktop of FIG. 1 illustrating the cooking area (shown in dash-dot-dot lines) and camera viewing areas (shown in broken lines).

FIG. 3 is a side sectional view of the cooktop system, illustrating the cooking area (shown in dash-dot-dot lines) and camera viewing areas (shown in broken lines).

FIG. 4 is a side sectional view of an enlarged portion of the cooktop system, illustrating a camera module assembled to a viewing region of the cooktop.

FIG. 5 is a schematic illustration of the connection of the cooktop system to a network.

FIG. 6 is a schematic diagram of the cooktop system

FIG. 7 is a flow chart illustrating the function of the cooktop system.

### DETAILED DESCRIPTION

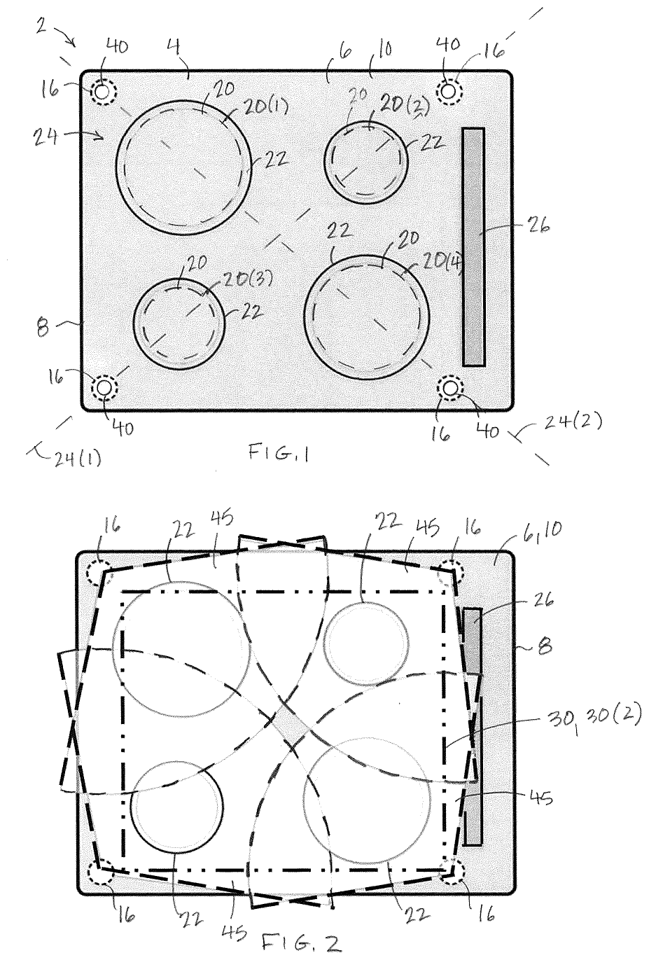

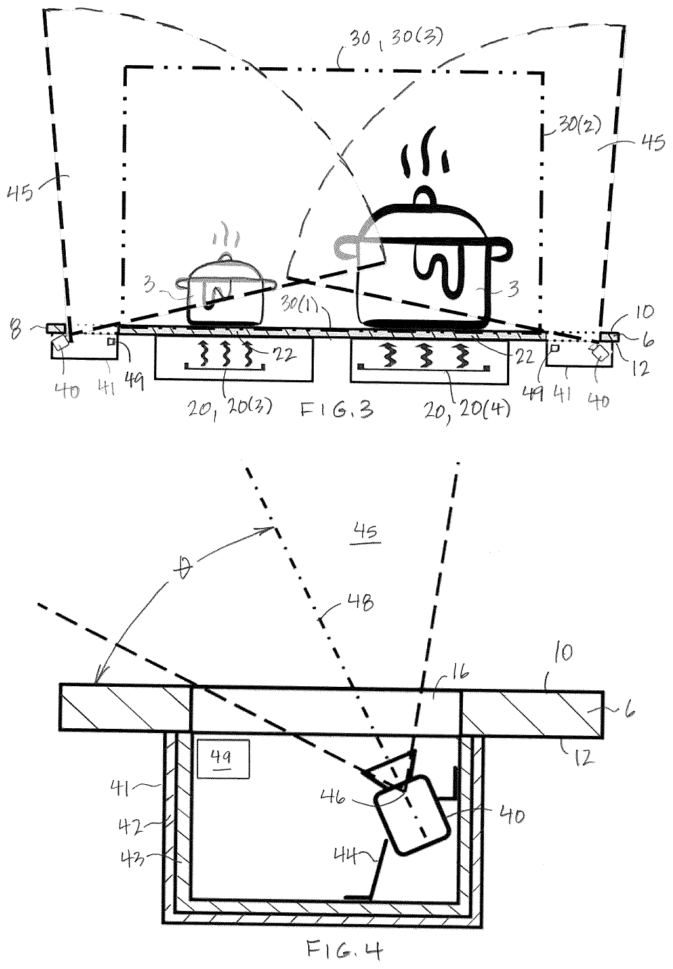

Referring to FIGS. 1-2 and 6, a cooktop system 2 includes a cooktop 4 that includes heating elements 20 that are used to directly, or indirectly, heat an object such as a cooking utensil 3 and its contents. The cooktop system 2 includes cameras 40 that record image data of the cooking area 30 that overlies the cooktop 4 in the vicinity of the heating elements 20. In addition, the cooktop system 2 includes a controller 50 that receives the image data from the cameras, processes the image data to identify cooking events and performs a response function based on the identified cooking event. Details of the cooktop system 2 including the cooktop 4, the cameras 40 and the controller 50 will now be described in detail. In addition, the response functions performed by the cooktop system 2 in response to detected cooking events will also be described in detail.

Referring to FIGS. 1-3, cooktop 4 includes a base panel 6 that serves as a cooktop surface. The cooktop 4 may be used as an isolated appliance or may be paired with an oven (not shown). When paired with an oven, the cooktop 4 and oven are frequently incorporated into a cabinet (not shown) with the cooktop 4 serving as the cabinet upper surface and with the oven underlying the cooktop 4.

The base panel 6 is a generally rectangular ceramic glass plate having an outer surface 10, an inner surface 12 that is opposite the outer surface 10 and a peripheral edge 8 that extends between the outer and inner surfaces 10, 12 and defines a border of the base panel 6. Although in the illustrated embodiment, the base panel 6 is opaque and may, for example, appear as dark brown or black, the base panel 6 is not limited to this configuration.

The base panel 6 supports heating elements 20 used, for example, in heating or cooking operations. In the illustrated embodiment, the cooktop 4 includes four heating elements 20(1), 20(2), 20(3), 20(4) but is not limited to having four heating elements 20(1), 20(2), 20(3), 20(4). For example, the cooktop 4 may have as few as one heating element or may have eight or more heating elements. The heating elements 20(1), 20(2), 20(3), 20(4) may be various sizes and may each have a different size than the others.

The heating elements 20(1), 20(2), 20(3), 20(4) may employ any suitable method for heating or cooking the cooking utensil 3 and its contents. In one embodiment, for example, the heating elements 20(1), 20(2), 20(3), 20(4) use a heat transfer device, such as electric coils or gas burners, to heat the cooking utensil 3 and its contents. In other embodiments, however, the heating elements 20(1), 20(2), 20(3), 20(4) may use an induction heating device to heat the cooking utensil 3 directly. In sum, the heating elements 20(1), 20(2), 20(3), 20(4) may include a gas burner, a resistive heat device, a radiant heat device, an induction heat device, or another suitable heating element. In the illustrated embodiment, the heating elements 20(1), 20(2), 20(3), 20(4) are resistive heating devices that are mounted to the base panel inner surface 12. Heat generated by a heating element 20 is transferred via conduction to the utensil 3, which rests on the base panel outer surface 10, via a heating region 22 of the base panel 6 that directly overlies the heating element 20.

In the illustrated embodiment, the four heating elements 20(1), 20(2), 20(3), 20(4) are arranged in a two-by-two array 24 that is surrounded by and spaced apart from the base panel peripheral edge 8. The heating region 22 of the base panel 6 overlies each of the four heating elements 20(1), 20(2), 20(3), 20(4) and has substantially the same size and shape as the respective heating element 20 that it overlies.

The cooktop 4 includes a control panel 26 that serves as a user interface. The control panel 26 may be integrated into the base panel 6 (shown) or alternatively may be located in another suitable location such as a backsplash or a front panel of the appliance cabinet. The control panel 26 includes input components or controls (not shown) through which a user may select various operational features and modes and monitor the cooking progress of the cooktop 4. The controls may be one or more of a variety of electrical, mechanical, or electro-mechanical input devices. The controls may include, for example, rotary dials, knobs, push buttons, and touch pads. The controls are in electrical communication with the controller 50. In some embodiments, the control panel 26 also (or alternatively) includes a display component, such as a digital or analog display and/or touch screen that is in communication with the controller 50.

The base panel 6 includes transparent viewing regions 16 that serve as camera viewing windows. In the illustrated embodiment, the base panel 6 includes four viewing regions 16. The viewing regions 16 are disposed between the array 24 and the base panel peripheral edge 8 such that one viewing region 16 is disposed in each corner of the base panel 6. In other words, a viewing region 16 is provided in the base panel 6 on each of opposed sides of the array 24 of heating elements 20 along the two diagonals 24(1), 24(2) of the array 24. The viewing regions 16 enable the cameras to view the area immediately above the cooktop outer surface including the area occupied by the cooking utensils. The viewing regions 16 are small in area relative to the size of the heating regions 22. For example, the viewing regions 16 may have an area that is in a range of three to thirty percent of the area of the heating regions 22. Although the viewing regions 16 are illustrated as having a circular profile when viewed facing the base panel outer surface 10, the viewing regions may have other profiles such as circular sector or polygonal.

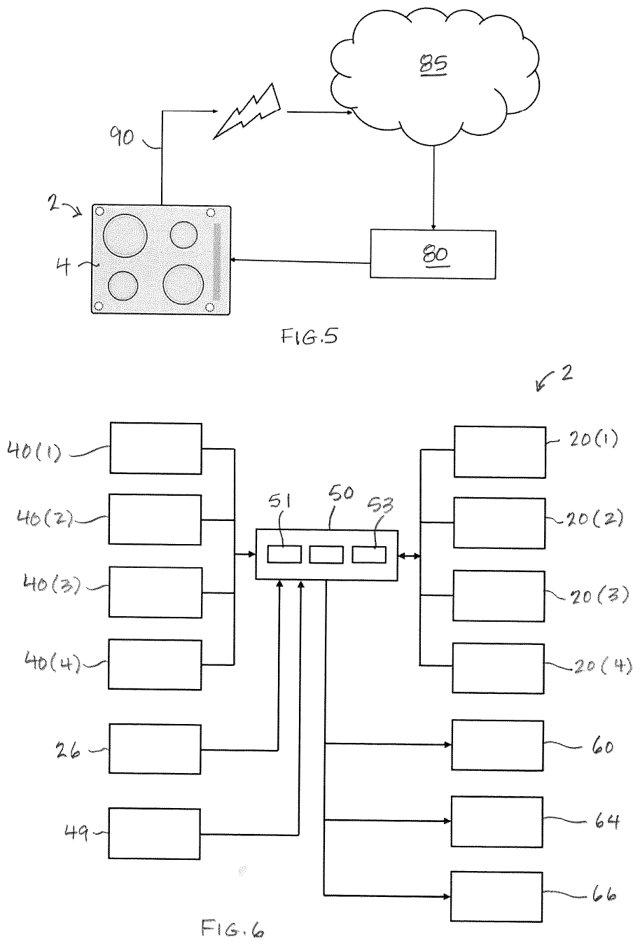

Referring also to FIG. 4, cooktop system 2 includes a camera 40 for each viewing region 16. Generally, each camera 40 may be any type of device suitable for capturing a picture or video. As an example, each camera 40 may be a video camera or a digital camera with an electronic image sensor (e.g., a charge coupled device (CCD) or a CMOS sensor).

A camera 40 is disposed underneath (e.g., directly below, and, in particular on a side of the base panel 6 corresponding to the inner surface 12) the base panel 6 at each viewing region 16. Thus, in the illustrated embodiment, the cooktop system 2 includes four cameras 40(1), 40(2), 40(3), 40(4). In some embodiments, each camera 40 is part of a camera module 41 that includes a module housing 42. The camera 40 is disposed in the module housing 42, and the module housing 42 is secured to the base panel inner surface 12 at a location corresponding to a viewing region 16. The camera module 41 may include other ancillary structures and devices that facilitate stable positioning and operation of the camera 40, including an insulation layer 43 that insulates the camera 40 from heat, a camera mounting bracket 44, etcetera. In other embodiments, the camera 40 may be free of a module. In such embodiments, the camera 40 itself may be secured directly to the base panel inner surface 12.

Each camera 40 is configured to collect image data from a corresponding imaging volume 45 of the camera 40. The imaging volume 45 of a given camera 40 extends through the corresponding viewing region 16 and intersects a portion of the cooking area 30 that overlies the entire cooktop 4. As seen in the figures, most of the imaging volume 45 is located on a side of the base panel 6 corresponding to the outer surface 10. The imaging volume 45 has a conical shape and thus can be partially defined by an apex 46 and a center axis 48. In cases where the camera 40 is, for example, a CCD camera, the apex 46 is positioned at the center of the CCD detector (not shown). In addition, the center axis 48, which passes through the apex 46 and is perpendicular to the CCD detector, defines the viewing angle of the camera 40. The camera 40 is angled relative to the base panel 6 such that the center axis 48 extends through the viewing region 16 and the imaging volume 45 overlies the nearest adjacent heating region 22. To this end, the angle θ of the center axis 48 relative to the base panel outer surface 10 is in a range, for example, of 30 degrees to 70 degrees. By this configuration, although the camera 40 is positioned to one side of the utensil 3 that is resting on the heating region 22, the utensil 3 and a portion of the cooking area 30 above the utensil 3 are in the view of the camera 40. More particularly, the utensil 3 and a portion of the cooking area 30 above the utensil 3 are disposed in the imaging volume 45 of the camera 40.

The orientation of the center axis 48 reflects observation direction of a given camera 40. In the cooktop system 2, the center axis 48 of each camera 40 to directed toward the cooking area 30 that overlies the cooktop 4. As used herein, the term “cooking area” 30 refers to the region that is occupied by utensils 3 when a utensil 3 rests on each heating element 20. Thus, in the illustrated embodiment, the cooking area 30 is a rectangular volume that has a lower boundary 30(1) corresponding to the base panel outer surface 10 and a peripheral boundary 30(2) corresponding to a closed shape that closely surrounds the group of four heating elements 20(1), 20(2), 20(3), 20(4) including the respective heating regions 22. In addition, the cooking area 30 has an upper boundary 30(3) that is parallel to the lower boundary and spaced apart from the lower boundary a distance corresponding to twice the height of a large pot. In the illustrated embodiment, for example, the lower and upper boundaries 30(1), 30(3) are spaced apart a distance of about 0.6 meters. In addition, the center axes 48 of the four cameras 40 intersect at a location that is at or above the upper boundary and is vertically aligned with a center of the upper and lower boundaries. The imaging volume 45 of each camera 40 partially overlaps the imaging volume of the other cameras 40 of the cooktop system 2 so that information for a given heating region 22 may be a compilation of data from multiple cameras 40. By providing a camera 40 at each corner of the base panel 6, all cameras 40 can detect images of the entire cooking area. In addition, by combining the camera images together, the controller 50 may determine how many utensils 3 are placed on the cooktop 4 and more accurately identify cooking events.

In some embodiments, the cooktop system 2 may include sensors 49 to augment detection and identification of cooking events that occur during use of the cooktop 4. The sensors 49 may include one or more of a thermal sensor, a microphone, a moisture sensor and/or other appropriate sensor. In some embodiments, the sensor 49 may be incorporated into the cameras 40. For example, a CCD camera that detects infrared radiation may be considered to be a thermal sensor. In other embodiments, the sensor(s) 49 may be provided separately in addition to the cameras 40 and may be disposed at locations appropriate for the given sensor 49 with respect to the base panel 6 of the cooktop. For example, a microphone may be provided in each camera module housing 42 so as to detect cooking sounds (boiling, sizzling, popping) associated with the respective adjacent heating region 22. In another example, a temperature sensor may be provided for each heating element 20 and configured to detect a temperature of the heating element 20 or the corresponding heating region 22.

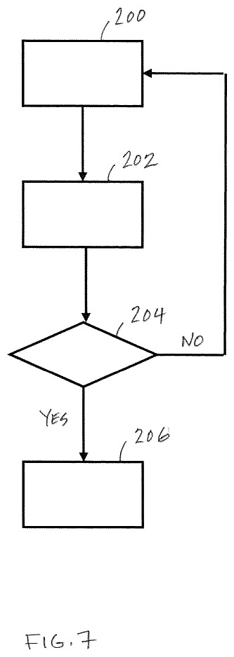

Referring to FIGS. 5 and 6, the cooktop system 2 includes the controller 50 that receives the image data from the cameras, processes the image data to identify cooking events and performs a response function based on the identified cooking event. Each camera 40 is in operable communication with the controller 50 such that controller 50 may receive an image signal from the camera 40 corresponding to the picture captured by the camera 40. Once received by controller 50, the image signal may be further processed at controller 50. For example, in some embodiments, the data from the sensors 49 may also be used to augment the image data in order to identify cooking events. In addition, or alternatively, data may be transmitted to a separate device (e.g., a remote server 80) in live or real-time for remote viewing (e.g., via one or more social media platforms).

The controller 50 is communicatively coupled (i.e., in operative communication) with the control panel 26 and its controls. The controller 50 is communicatively coupled with the sensors 49. The controller 50 may also be communicatively coupled with various operational components of cooktop 4 as well, including, but not limited to, the heating elements 20 and cameras 40. As used herein, the term “communicatively coupled” may refer to a direct wired connection via for example conductive signal lines, shared communication busses, or alternatively may refer to a wireless connection. Thus, controller 50 can receive information from these devices and selectively activate and operate the various operational components.

In some embodiments, controller 50 includes one or more memory devices 51 and one or more processors 52. The processors 52 may be any combination of general or special purpose processors, CPUs, or the like that can execute programming instructions or control code associated with operation of the cooktop system 2. The memory devices (i.e., memory) 51 may represent random access memory such as DRAM or read only memory such as ROM or FLASH. In some embodiments, the processor 52 executes programming instructions stored in memory 51. The memory 51 may be a separate component from the processor 52 or may be included onboard within the processor 52. Alternatively, controller 50 may be constructed without using a processor 52, for example, using a combination of discrete analog or digital logic circuitry (such as switches, amplifiers, integrators, comparators, flip-flops, AND gates, and the like) to perform control functionality instead of relying upon software.

In some embodiments, the controller 50 includes a network interface such that the controller 50 can connect to and communicate over one or more networks (i.e., network 90). The controller 50 may also include one or more transmitting, receiving, or transceiving components 53 for transmitting and/or receiving communications with other devices communicatively coupled with the cooktop system 2. Additionally, or alternatively, the transmitting, receiving, or transceiving components 53 can be located off board controller 50. Generally, the controller 50 may be positioned in any suitable location throughout cooktop 4. For example, the controller 50 may be located proximate the control panel 26.

The various functions performed by the controller 50 may be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

The network 90 can be any suitable type of network, such as a local area network (e.g., intranet), wide area network (e.g., internet), low power wireless networks (e.g., Bluetooth Low Energy (BLE)), or some combination thereof and can include any number of wired or wireless links. In general, communication over the network 90 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). In some embodiments, a remote server 80, such as a web server, is in operable communication with the cooktop system 2. The server 80 can be used to host a social media platform (e.g., FACEBOOK™, INSTAGRAM™, SNAP-CHAT™, TWITTER™, etc.). In other words, remote server 80 may be a social media platform server. Additionally, or alternatively, the server 80 can be used to host an information database (e.g., a recipe database). The server 80 can be implemented using any suitable computing device(s). The server 80 may include one or more processors 82 and one or more memory devices (i.e., memory) 81. The one or more processors 82 can be any suitable processing device (e.g., a processor core; a microprocessor, an ASIC, a FPGA, a microcontroller, etc.) and can be one processor or a plurality of processors that are operatively connected. The memory devices 81 can include one or more non-transitory computer-readable storage mediums, such as RAM, ROM. EEPROM, EPROM, flash memory devices, magnetic disks, etc., and combinations thereof. The memory devices 81 can store data and instructions which are executed by the processor to cause remote server 80 to perform operations. For example, instructions could be instructions for receiving/transmitting images or image signals, transmitting receiving recipe signals, etc.

The remote server 80 includes a network interface such that remote server 80 can connect to and communicate over one or more networks (e.g., the network 90) with one or more network nodes. The network interface can be an onboard component or it can be a separate, off board component. In turn, the remote server 80 can exchange data with one or more nodes over the network 90. In particular, the remote server 80 can exchange data with the controller 50. It is understood that the remote server 80 may further exchange data with any number of user devices 60 over the network 90. The user devices 60 can be any suitable type of computing device, such as a general purpose computer, special purpose computer, laptop, desk-top, integrated circuit, mobile device, smartphone, tablet, or other suitable computing device. In the case of a social media platform, images (e.g., static images or dynamic video), audio, or text may thus be exchanged between controller 50 of the cooktop system 2 and various separate user devices 60 through the remote server 80.

The controller 50 may also use AI techniques such as machine learning to identify cooking events, for example boiling water. In this example, the controller 50 may learn that a few, infrequent small bubbles have been generated when the degree of generation of water vapor in the image photographed using a camera 40 is a first level corresponding to a warmed state. In addition, the controller 50 may learn that a many, frequent small bubbles have been generated when the degree of generation of water vapor in the image photographed using a camera 40 is a second level corresponding to a simmering state in which steam is generated more than as in the first level. Still further, the controller 50 may learn that constant large bubbles have been generated when the degree of generation of water vapor in the image photographed using a camera 40 is a third level corresponding to a boiling state. After repeated instances of such learning, the controller 50 may recognize a given level, for example a third level when water is boiling.

In some embodiments, the controller 50 may also use information detected by one or more sensors 49 to augment understanding and learning. For example, a microphone may be used to verify whether the level of vaper generation is a second or third level since sounds associated with simmering are quite different than those of water at a full boil. In another example, the detected temperature of a heating element 20 and elapsed time of the heating element at the detected temperature may also inform the identification of a cooking event by the controller 50. In still another example, in cases where the camera 40 includes a CCD detector, the camera 40 may be used to detect flame via the temperature profile of the corresponding imaging volume 45.

The cooktop system 2 may regularly connect to the remote server 80 and/or cloud 85 via the network 90 to obtain updated AI models. This function gives the cooktop system 2 the ability to continue improving the performance of cooking event detection and adapt to the cooking environment and cookware in the kitchen. Furthermore, the cooktop system 2 may also upload data associated with the detected cooking events to the remote server 80 and/or cloud 85 where the AI models may be continuously improved.

Referring to FIG. 7, the cooktop system 2 may be used to identify cooking events. For example, when the cooktop 4 is in the status of power on, the cameras 40 continuously detect image date corresponding to the cooking activities on the cooktop 4 in real time (step 200). The collected image may be stored locally in memory 51 of the controller 50, stored in the server memory 81 and/or stored in the cloud 85. Following data collection, the image data may be processed by the controller 50. During processing (step 202), the AI algorithms analyze the image data to identify cooking events, which may include, for example, not boiling, simmering, hard boiling, boiling over, burning of utensil contents, etcetera. If no cooking events are identified, steps 200 and 202 are repeated.

Upon identification of a cooking event (step 204), the controller may perform a response function (step 206) based on the identified cooking event when appropriate. In cases where the user of the cooktop is waiting for the contents of the utensil to boil, the response function performed by the controller 50 upon identification of a boiling event may be to send an alert to the user device 60 (i.e., sending a notification text to the smart phone of the user). In cases where the cooktop system is controlling the cooktop 4 to perform the steps of a recipe stored in memory, the response function performed by the controller 50 upon identification of a boiling event may be to change a heat setting of the heating element 20 or, alternatively, to set a timer 64 so as to allow the contents of the utensil 3 to continue to boil for a predetermined amount of time. If a cooking event is identified that is considered to be a hazardous event, the response function performed by the controller 50 upon identification of a hazardous event may be to trigger an audio/voice alarm 66. In addition, or alternatively, the response function performed by the controller 50 may be to change a heat setting of the heating element 20 (e.g., powering off the heating element 20) to minimize or avoid damage to the cooktop system, the utensil, and/or the environment. In the case of any detected cooking event (hazardous or non-hazardous), the response function performed by the controller 35 may be to send the information to the remote server 80 or cloud 85 for example to update a cooking assistance application or to summon emergency services.

Although in the illustrated embodiment, the base panel 6 is constructed of ceramic glass, the base panel is not limited to this material. For example, in other embodiments, the base panel 6 may be constructed a metal such as steel or other suitable metallic or non-metallic material.

In the illustrated embodiment, the camera module 41 is secured to the underside of the base panel 6 at a location that coincides with a viewing region 16. In other embodiments, the viewing region 16 may be replaced with an opening in the base panel 6, and the camera module 41 includes a transparent cover. When mounted within the opening, the transparent cover provides the protective window through which the camera views the cooking area 30.

Selective illustrative embodiments of the cooktop system and cooktop are described above in some detail. It should be understood that only structures considered necessary for clarifying the cooktop system and cooktop have been described herein. Other conventional structures, and those of ancillary and auxiliary components of the cooktop system and cooktop, are assumed to be known and understood by those skilled in the art. Moreover, while working examples of the cooktop system and cooktop have been described above, the cooktop system and cooktop are not limited to the working examples described above, but various design alterations may be carried out without departing from the cooktop system and cooktop as set forth in the claims.

What is claimed is:

1. A cooktop, comprising:
a base panel including an outer surface, an inner surface that is opposite the outer surface and a transparent first viewing region;
a first heating element that is secured to the inner surface in such a way as to be able to supply heat to a first heating region of the base panel;
a first camera that is positioned on a side of the base panel corresponding to the inner surface at a location corresponding to the first viewing region, the first camera configured to collect image data from a first imaging volume, where the first imaging volume is positioned on a side of the base panel corresponding to the outer surface at a location corresponding to the first heating region and the first camera views the first imaging volume through the first viewing region; and
a controller that is configured to
receive the image data collected by the first camera,
process the image data to identify a corresponding cooking event, and
perform a response function based on the identified cooking event.

2. The cooktop of claim 1 wherein the first imaging volume has a conical shape, an apex of the conical shape being located on the camera and an axis of the conical shape extends through the first viewing region and the first imaging volume.

3. The cooktop of claim 2, wherein the axis of the conical shape is at an acute angle relative to a plane defined by the base panel.

4. The cooktop of claim 1, wherein the first viewing region has a circular shape when the base panel is viewed in a direction perpendicular to the outer surface.

5. The cooktop of claim 1, wherein the first viewing region has a circular sector shape when the base panel is viewed in a direction perpendicular to the outer surface.

6. The cooktop of claim 1, wherein
the base panel comprises a transparent second viewing region,
the cook top comprises:
a second heating element that is secured to the inner surface in such a way as to be able to supply heat to a second heating region of the base panel; and
a second camera that is positioned on a side of the base panel corresponding to the inner surface at a location corresponding to the second viewing region, the second camera configured to collect image data from a second imaging volume, where the second imaging volume is positioned on a side of the base panel corresponding to the outer surface at a location corresponding to the second heating region and the second camera views the second imaging volume through the second viewing region.

7. The cooktop of claim 6, wherein the first imaging volume and the second imaging volume partially overlap.

8. The cooktop of claim 6, wherein the controller is configured to
receive the image data collected by each of the first camera and the second camera,
process the collected image data including
using data from one of the first camera or the second camera to compensate for or supplement data from the other of the first camera and the second camera, and
identifying a corresponding cooking event, and
perform a response function based on the identified cooking event.

9. A system for detecting cooking events during a cooking process performed on a cooktop, the system comprising:
the cooktop, the cooktop including:
a base panel comprising an outer surface, an inner surface that is opposite the outer surface and a transparent first viewing region,
a first heating element that is secured to the inner surface in such a way as to be able to supply heat to a first heating region of the base panel, and
a first camera that is positioned on a side of the base panel corresponding to the inner surface at a location corresponding to the first viewing region, the first camera configured to detect image data in a first imaging volume, where the first imaging volume is positioned on a side of the base panel corresponding to the outer surface at a location corresponding to the first heating region and the first camera views the first imaging volume through the first viewing region; and
a controller that is configured to
receive the image data generated by the first camera,
process the image data to identify, a corresponding cooking event, and
perform a response function based on the identified cooking event.

10. The system of claim 9, wherein processing the image data to identify cooking events comprises
analyzing the image data to identify image contents,
comparing the image contents to a pre-stored content library that includes known images of cooking events and at least one response function that is mapped to each known image of a cooking event,
identifying a one of the known cooking events that most closely matches the image contents,
based on the identified one of the known cooking events, performing the response function or response functions that are mapped to the one of the known cooking events.

11. The system of claim 10, wherein analyzing the image data to identify image contents is performed using artificial intelligence algorithms.

12. The system of claim 9, wherein the controller comprises a communication device that is configured to transmit information to, and receive information from, a remote network.

13. The system of claim 12, wherein information transmitted to the remote network includes cooking event data.

14. The system of claim 12, wherein
analyzing the image data to identify, image contents is performed using an artificial intelligence algorithm stored by the controller, and
information received from the remote network includes updates to the artificial intelligence algorithm that improve the function of the artificial intelligence algorithm.

15. The system of claim 10, wherein the at least one response function comprises activating at least one of an audible alarm, a visible alarm, transmission of an alert to a personal computing device via the remote network, transmission of an alert to a public safety organization via the remote network, transmission of an alert to a private security organization via the remote network.

16. The system of claim 10, wherein the at least one response function comprises controlling the first heating element to change an amount of heat provided by the heating element.

17. The system of claim 10, wherein the at least one response function comprises controlling the first heating element to change an operation state of the heating element.
